(19) United States
(12) Patent Application Publication
(10) Pub. No.: US 2022/0416548 A1
(43) Pub. Date: Dec. 29, 2022

(54) OPERATIONAL PLANNING FOR BATTERY-BASED ENERGY STORAGE SYSTEMS CONSIDERING BATTERY AGING

(71) Applicant: TWAICE Technologies GmbH, Munchen (DE)

(72) Inventors: Nicolas Killian, Munchen (DE); Oliver Eckstein, Munchen (DE); Johann Hirshmann, Egmating (DE); Philipp Berg, Munchen (DE); Sebastian Becker, Munchen (DE)

(21) Appl. No.: 17/355,578

(22) Filed: Jun. 23, 2021

(51) Int. Cl. H02J 7/00; H02J 3/00; G05B 19/042

(52) U.S. Cl. CPC H02J 7/005; H02J 7/0013; H02J 3/003; H02J 3/004; H02J 7/00712; G05B 19/042; H02J 2203/20; G05B 2219/2639

(57) ABSTRACT

Operational planning of energy storage systems using batteries, e.g., Lithium-Ion batteries, is disclosed. A method of operating at least one server node includes: obtaining one or more load profiles associated with one or more interfacing modes of a battery energy storage system with an electrical utility distribution system, and predicting one or more degradations of the battery energy storage system, the one or more degradations being associated with operating the battery energy storage system in the one or more interfacing modes, the one or more degradations being predicted using an aging model of batteries of the battery energy storage system, the aging model being based on the one or more load profiles.

### BACKGROUND

Battery-based energy storage systems (BESS) are proliferating. BESS can be connected to an electrical utility distribution system (power grid) and receive or provide electrical energy, i.e., to exchange energy.

BESS can help to support operation of the power grid, e.g., in scenarios where distributed generation is employed using electrical distributed energy sources with time-varying generation profile or time-varying demands.

### SUMMARY

There is a need for advanced techniques of operational planning for BESSs.

This need is met by the features of the independent claims. The features of the dependent claims define embodiments.

A method of operating at least one server node includes obtaining one or more load profiles. The one or more load profiles are associated with one more interfacing modes of a BESS with a power grid. The method also includes predicting one or more degradations of the BESS. The one or more degradations are associated with operating the battery energy storage system in the one or more interfacing modes. The one or more degradations are predicted using an aging model of batteries of the battery energy storage system. The aging model is based on the one or more load profiles.

A computer program or a computer-program product or a computer-readable storage medium includes program code. The program code can be loaded and executed by at least one processor. Upon loading and executing the program code, the at least one processor performs a method of operating at least one server node. The method includes obtaining one or more load profiles. The one or more load profiles are associated with one more interfacing modes of a BESS with a power grid. The method also includes predicting one or more degradations of the BESS. The one or more degradations are associated with operating the battery energy storage system in the one or more interfacing modes. The one or more degradations are predicted using an aging model of batteries of the battery energy storage system. The aging model is based on the one or more load profiles.

At least one server node is configured to obtain one or more load profiles. The one or more load profiles are associated with one or more interfacing modes of a BESS with a power grid. The at least one server node is further configured to predict one or more degradations of the BESS. The one or more degradations are associated with operating the battery energy storage system in the one or more interfacing modes. The one or more degradations are predicted using an aging model of batteries of the battery energy storage system. The aging model is based on the one or more load profiles.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a system according to various examples.

FIG. 2 schematically illustrates a device according to various examples.

FIG. 3 is a flowchart of a method according to various examples.

FIG. 4 schematically illustrates a graphical user interface (GUI) of a human-machine interface (HMI) according to various examples.

### DETAILED DESCRIPTION OF EXAMPLES

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various techniques generally relate to operation and operational planning of BESS. The BESS is connected to a power grid. Thus, the power exchange between the BESS and the power grid can be planned.

The BESS can include multiple rechargeable batteries in a certain network architecture. For instance, Lithium-Ion batteries could be used. For example, capacities of BESSs may be not less than 0.5 MW, optionally not less than 1 MW, optionally not less than 10 MW.

Specifically, long-term operational planning is possible, i.e., planning with a lookahead duration of hours, days, weeks, months, or even years. For instance, it would be possible to plan operation of the BESS beyond a time duration for which a concrete demand is known. Long-term operational planning may be agnostic of the concrete times of occurrences of specific charging and discharging micro-operations of each battery of the BESS; rather, the general framework of operational constraints may be set within which specific charging and discharging micro-operations are then executed. For instance, a short-term operational planning may define whether batteries are charged or discharged within such operational constraints imposed by the long-term planning. The short-term operational planning may be based on concrete energy exchange demands of the power grid. For instance, reference techniques of short-term operational planning are disclosed in: U.S. Pat. No. 10,489,731 B2.

According to various examples, it is possible to select one or more interfacing modes between the BESS and the grid. There are various possibilities available for defining interfacing modes. The interfacing modes may generally define a general operating strategy and/or operating constraints; the concrete operational profile, e.g., charging and discharging microoperations, may however not be defined by the interfacing mode. Thus, the interfacing modes may provide a ruleset for operation, but not the concrete operation itself. Different ones of the one or more interfacing modes may provide different ones of the following functionalities to the grid: (i) smooth power fluctuation; (ii) peak regulation; (iii) regulate frequency and/or voltage. Different interfacing modes may be associated with different trigger criteria to receive electrical power from the power grid or the provide electrical power to the grid. The different interfacing modes may be associated with different target state of charges (SoCs) of the BESS: for instance, it would be possible that for a certain interfacing mode a target SOC is high so that large amounts of energy could be delivered to the power grid; while, for another interfacing mode the target SOC is low so that large amounts of energy could be received from the power grid. For instance, one interfacing mode could be associated with a medium SoC in the range of 50%, so that electrical energy could be both buffered or provided. The different interfacing modes may be associated with different response times to receive or provide electrical power. Different interfacing modes can be associated with different operational constraints or operational profiles of the batteries of the BESS.

It is, as a general rule, possible that load profiles associated with different interfacing mode exhibit different operating strategies and/or operating constraints. It would be possible that load profiles associated with different interfacing modes specify different charging and discharging micro-operations.

It would in some scenarios be possible that a given load profile is associated with multiple interfacing modes. For instance, a load profile may be characterized by energy transfer of certain charging or discharging micro-operations. These energy transfers can have similar characteristics for different interfacing modes, e.g., charging and discharging micro-operations may have similar characteristics in terms of charging or discharging rate, depth of discharge, etc. However, it would be possible that certain energy transfers are triggered in response different trigger criteria. For instance, for primary power reserve or ancillary services as first examples of interfacing modes, a certain energy transfer is requested by the power grid. Differently, for arbitrage as a second example of interfacing modes, energy transfers are triggered depending on market prices. Some interfacing modes are summarized below in TABLE 1.

TABLE 1
Various examples of interfacing modes for exchanging electrical energy
between the BESS and the grid.

| Interfacing | |
|---|---|
| mode | Example description |
| Peak | Peak shaving is achieved through the process of charging |
| shaving | ESS when demand is low (off-peak period) and |
| | discharging when demand is high. The response time |
| | may be in the order of minutes. |
| Intra-day | Energy storage and provisioning is time shifted for cost |
| price | saving or arbitrage purposes. Thus, changes in the market |
| arbitrage | prices are monitored. |
| Primary | Positive and negative power demands can be balanced |
| power | within seconds. |
| reserve | |
| Secondary | Positive and negative power demands can be balanced |
| power | within minutes. |
| reserve | |
| Voltage | The ESS works on reactive power absorption or release |
| regulation | according to real-time need for regulation of transmission |
| | voltage. |
| Frequency | The ESS can charge or discharge power according to the |
| regulation | A/C power signal received each second. Under such a |
| | mode, the ESS can maintain a long-term operation at a |
| | set State of Charge value. |

Various examples are based on the finding that batteries of BESSs degrade during operation, due to charging and discharging micro-operations triggering aging mechanisms such as loss of electrode material, exfoliation, conversion of electrode materials, etc.

For example, one interfacing mode may be associated with high charging and discharging volumes, e.g., to increase revenue at the spot market, but this poses the risk of strong battery degradation. Too extensive battery degradation increases operating expenses significantly and can also pose a risk for the storage in terms of safety and risk and loss of performance warranties provided by a supplier. Also, it can have implications on the reliability and availability of the power grid, since with the intermittent availability of renewables, high availability of energy storages as a buffer is of increasing importance for the grid to avoid blackouts.

Various techniques are based on the finding that there is a wide variety of operating conditions of BESSs. BESSs are operated in various deployment scenarios, i.e., markets (i.e., having different compensation levels and/or compensation schemes for the functionality provided by the BESS to the grid) and under varying operating constraints (e.g., Depth of Discharge, Energy Throughput, Aging Shadow price, Temperature). These deployment scenarios differ not only in their revenue potential but in the way the BESS needs to be operated. The operation in different deployment scenarios impacts the battery degradation differently. Therefore, a complex optimization problem occurs between different interfacing modes, operating constraints and battery degradation. The BESS operator needs to ensure that at least the loss of value (shadow price) of battery degradation do not exceed the respective revenue in a market or use case. Too extensive battery degradation can also pose a risk for a BESS in terms of safety, availability, and performance. According to various examples, it is possible to take into account such and other variations in the operation and operational planning of the BESS.

According to various examples, an aging model is employed based on one or more load profiles associated with one or more interfacing modes. Thereby, one or more degradations of the batteries of the BESS can be predicted, for the one or more load profiles that are associated with the one or more interfacing modes. This, in turn, can help to determine a loss of value of the BESSs based on the respective degradation.

The choice of the appropriate interfacing mode—for operational planning—can then depend on the degradations predicted for each one of one or more interfacing modes. More specifically, according to various examples, it would be possible to select at least one interfacing mode for operation of the BESS. This selection can depend on one or more predicted degradations. It would be possible that based on the one or more predicted degradations, one or more losses of value of the BESSs due to battery degradation associated with each one of the interfacing modes are determined. Then, it would be possible that the selection depends on the one or more losses of value. As a general rule, the load profiles can specify energy transfer rates requested (e.g., within certain margins) or required by the power grid, e.g., in Watts.

It is then possible to determine, based on the load profiles, operational profiles of the batteries. These operational profiles can specify voltages and currents of each battery of the batteries of the battery and energy storage system. This can be determined based on an electrical model of the batteries and the BESS. To determine battery-specific voltages and currents, an architecture of the batteries of the battery energy storage system can be used.

The operational profiles can serve as an input to the aging model. It would also be possible to further process the operational profiles, e.g., to determine derived values such as state of charge, average state of charge, depth of discharge, charging rate, discharging rate, temperature. Then, such derived values can be provided as the input to the aging model, e.g., along with current and/or voltage.

It would be possible that the load profile specify the energy transfer rates as a function of time. I.e., it would be possible that for each point in time of a sequence of time points a respective energy transfer rate, e.g., including tolerance margins, specified. It would also be possible that respective energy transfer rates are specified in an event-based manner together with a likelihood of occurrence or frequency of occurrence. For instance, certain energy transfer events—e.g., defined by an amount and time duration, i.e., a certain rate—could be specified and a time probability distribution could be associated with the energy transfer events. Subject to statistical fluctuation, it would then be possible to derive concrete time sequences of the energy transfer. It would also be possible to specify a statistical histogram of relative occurrences of energy transfer rates in different regimes (e.g., different energy volume and/or power).

Likewise, for the operational profiles, it would be possible to specify time sequences are voltages and currents. It would also be possible to specify statistical histograms of relative occurrences of operation of the battery at certain voltage or current regimes.

As a general rule, various types and kinds of aging models could be employed. For instance, the aging model may be based on an equivalent circuit model (considering electric/thermal states) and a semi-empirical aging model. It would be possible that aging parameters of the aging model are updated based on monitoring operation of the batteries of the BESSs, i.e., using field data. According to various examples, an aging model may include an iterative process where an electrical and thermal state estimation is executed for the battery and then followed by an aging prediction for the respective estimated electrical and thermal states. An example aging model is disclosed in WO 2020/224724 A1. Another example aging model is disclosed in Schmalstieg, Johannes, et al. “A holistic aging model for Li (NiMnCo) O2 based 18650 lithium-ion batteries.” Journal of Power Sources 257 (2014): 325-334. Other aging models may be implemented using machine-learning algorithms. For instance, it would be possible to use artificial neural network algorithms. For instance, an artificial neural network algorithm may receive, as an input, the operational profile of a battery, e.g., a time-resolved sequence of operational parameter values such as voltage or current. The artificial neural network would also receive, as the input, the operational profile as a histogram where the time duration of the batteries operating in a given operational regime is specified. The artificial neural network algorithm can be trained based on the ground truth that is obtained from laboratory measurements. As a general rule, it would be possible that the one or more degradations are predicted using the aging model being executed on a server node. I.e., cloud-based prediction and cloud-based operational planning would be possible. This is, in particular, helpful for scenarios where multiple battery energy storage systems need to be maintained and organized.

For instance, long load profiles (e.g., months or years) can be analyzed with respect to degradation at the planning phase of the BESSs; it would also be possible to consider shorter load profiles (e.g., hours or days or weeks) to decide, e.g., on a monthly basis, how to operate the storage.

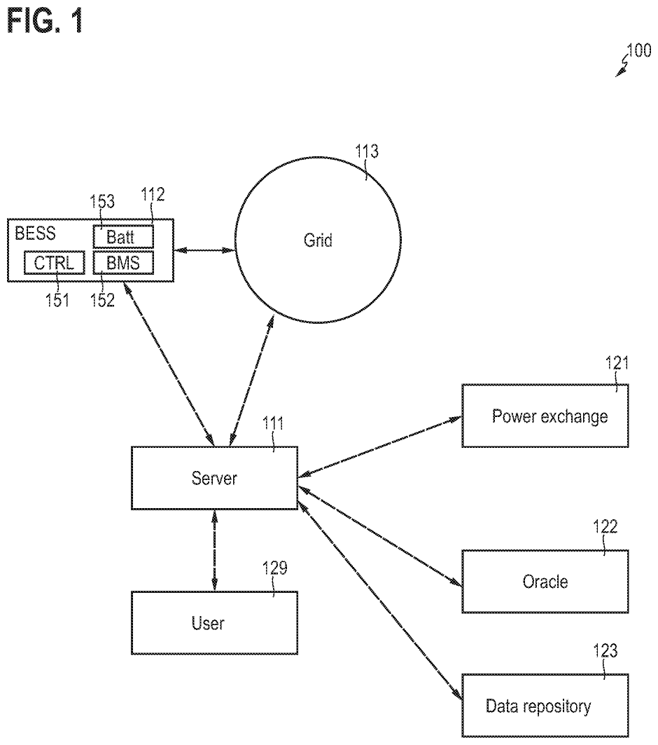

FIG. 1 schematically illustrates a system 100 according to various examples. A BESS 112 includes multiple batteries 153 and is connected to a power grid 113. The BESS 112 also includes a control unit 151 and a BMS 152.

The control unit 151 can implement short-term control of the operation of the BESS. For instance, the control unit 151 can implement a short-term optimization to determine one or more operational parameters of the BESS 112, e.g., using lookahead durations in the order of seconds or minutes. For instance, the control unit 151 can determine whether the batteries 153 are to be charged or discharged or maintained at a given state of charge, a charging rate, a discharging rate, etc. More generally, the control unit 151 can activate or deactivate one or more charging or discharging micro-operations within operating requirements or constraints imposed by a given interfacing mode governing the general operational strategy of the BESS 112 towards the power grid 113.

A server node 111 is provided that is connected to the BESS 112 and, optionally, to the power grid 113. The server node 111 can also be connected to a power exchange node 121, an oracle server node 122, and/or a data repository node 123. The server node 111 can be accessed by a user terminal node 129.

The server node 111 can provide an HMI, e.g., including and GUI, that can be accessed by a user via the terminal node 129. For instance, operational planning of operations of the battery energy storage system 112 can be implemented via the HMI.

The system 100 of FIG. 1 is an example implementation. For instance, it would be optional that the server node 111 is connected to the power exchange node 121, the oracle server node or the data repository node 123.

According to various examples, the server node 111 provides cloud-based functionality for operation and operational planning of the BESS 112. Specifically, the server node 111 can predict one or more degradations of the BESS for one or more interfacing modes of the BESS 112 and the power grid 113. The server node 111 can predict respective losses of value of the BESS 112 when operating in different interfacing modes, e.g., in relative terms (e.g., parameterized with respect to the actual power exchange demand) or in absolute terms (e.g., as an aggregated power loss value). The server node 111 can select at least one interfacing mode of multiple interfacing modes based on the loss of value or the degradation. For instance, an optimization may be implemented.

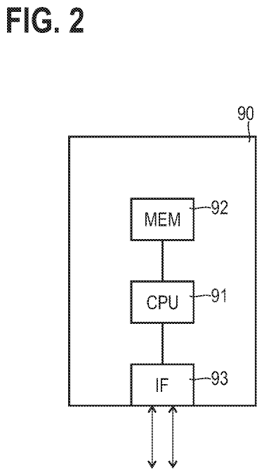

FIG. 2 schematically illustrates a device 90. For instance, the device 90 could implement one or more of the server node 111, the user terminal node 129, the power exchange node 121, the oracle server node 122, or the data repository node 123. For instance, the device 90 could implement the control unit 151 or the BMS 152 of the BESS 112.

The device 90 includes a processing unit 91 that could be implemented, e.g., by a general-purpose processor (CPU), a graphic processor unit, a field-programmable gated array, or an application-specific integrated circuit. The processing unit 91 can load program code from a memory 92 and execute the program code. Data can be exchanged with the various nodes of the system 100 via an interface 93. Upon loading and executing the program code, the processing unit 91 can perform techniques as disclosed herein, e.g., with respect to the executing and aging simulation of degradation of the batteries 153 of the BESS 112, predicting the degradation for each one of multiple interfacing modes of the BESS 112 and the power grid 113, obtaining load profiles associated with the interfacing modes, determining loss of values of the BESS based on a respective degradations, performing a long-term planning of the operation of the BESS 112 based on the loss of value or the one or more degradations determined for interfacing modes, etc.

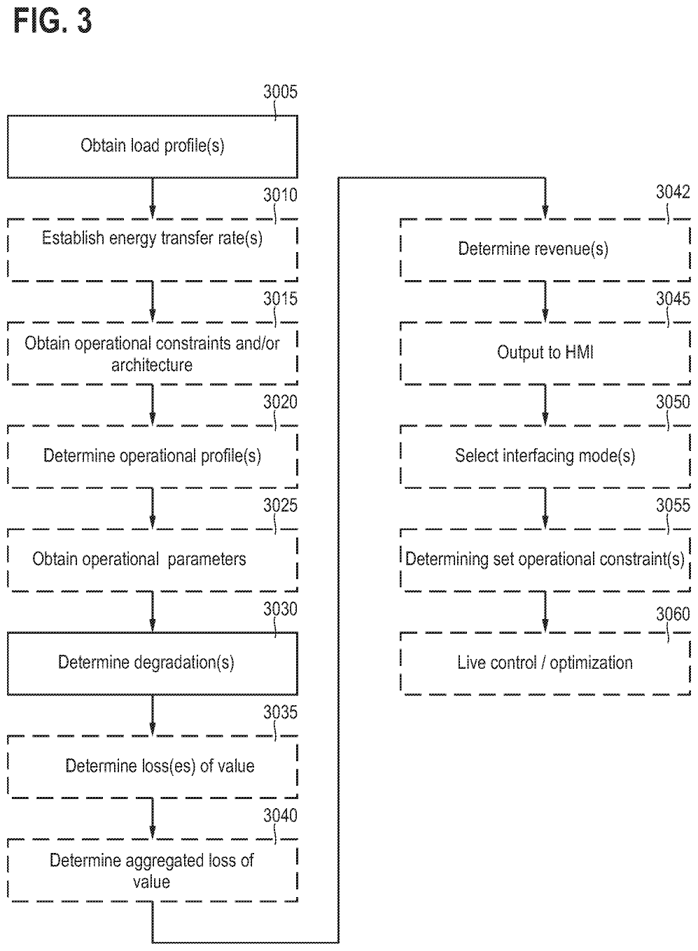

FIG. 3 is a flowchart of a method according to various examples. The method of FIG. 3 generally pertains to operational planning of a BESS, e.g., the battery and energy storage system 112 of the system 100 according to FIG. 1. The method of FIG. 3 can be executed by a cloud node, e.g., the server node 111 of the system 100. More specifically, the method of FIG. 3 could be executed by a processor—e.g., the processing unit 91 of the device 90—upon loading program code from a memory—e.g., the memory 92.

Optional boxes are labeled with dashed lines.

At box 3005, one or load profiles are obtained. Different ones of the one or more load profiles can be associated with different interfacing modes for exchanging electrical energy between the BESS 112 and the power grid 113. For instance, example interfacing nodes have been disclosed above in connection with TAB. 1.

As a general rule, there are various options available for obtaining the one or more load profiles at box 3005. For instance, it would be possible that the one or more load profiles are obtained from a data repository node 123. The one or more load profiles could also be obtained from an energy exchange node 121.

It would be possible that the one or more load profiles are predetermined for a class of power grids 113. This means that the one or load profiles may not specifically relate to a concrete instance of the power grid 113 for which the operation of the BESS 112 is planned, but may be generally determined for multiple comparable power grids.

Such generic load profiles specifically enable operational planning for the BESS 112 in a planning phase, i.e., prior to go-live of the BESS 112. In such a scenario, specific load profiles may not yet be available from monitoring of the exchange of electrical energy between the BESS 112 in the power grid 113. Further, generic load profiles can also be helpful where previously untested interfacing modes are to be evaluated.

It would be possible that the one or more load profiles are obtained based on monitoring the operation of the power grid 113 and/or of the BESS 112. It would be possible that the one or more load profiles are obtained after a go-live of the BESS 112.

As a general rule, it would be possible that the one or load profiles pertain to historical measurements data. Such a scenario can be helpful where operational planning is to be implemented based on actual measurement data.

As a general rule, the load profiles can take various forms. In one example, the load profiles can specify the absolute required energy transfer between the power grid 113 and the BESS 112 per time. I.e., the load profile can specify the absolute value of the required power throughput at a connection between the BESS 112 and the power grid 113 for a given interfacing mode. The demand from the power grid 113 can thus be incorporated into the load profiles. This means that it can be possible to unambiguously conclude on the operational profiles of the batteries 153 of the battery energy storage system 112 based on the one or load profiles obtained for the one or interfacing modes.

In other examples, it would also be possible that the load profiles specify the energy transfer rate in parametrized form. Here additional information may be required to conclude on the operational profiles for the batteries 153. For instance, respective charging or discharging micro-operations may be generally specified, but the frequency of occurrence of these micro-operations may be subject to parameter variation. In such a scenario, a combination of the parametrized one or more load profiles with a prediction of the energy transfer rates—that can be established at box 3010—for each one of the one or more interfacing modes may yield the respective one or more operational profile (later, at box 3020). For instance, higher energy transfer rates can pertain to higher charging or discharging rates, more frequent charging or discharging operations, etc.

As a general rule, there are various options available for establishing one or energy transfer rates for one or interfacing modes at box 3010. For instance, it would be possible that predictions of the energy transfer rates are obtained from a grid operator of the power grid 113 or the energy exchange node 121. Grid prediction tools may indicate expected instabilities and grid behavior. Alternatively or additionally, it would be possible to obtain environmental forecast data that is associated with an operational environment of the power grid 113. Then, at box 3010, it would be possible to determine predictions of the energy transfer rate at the server node 111 based on the environmental forecast data. For instance, such environmental forecast data could pertain to, e.g., weather forecasts, traveling intensity forecasts, holiday seasons, etc. All such information is known to impact the operation of the power grid 113 and, thus, have an impact on the requested energy transfer rate of the power grid 113 towards or from the battery energy storage system 112.

At optional box 3015, the server node, obtains one or more operational constraints of the batteries of the BESS 112. Alternatively or additionally, the server node 111 can obtain a network architecture of the network formed by the batteries 153. For instance, different design options are known for battery and energy storage systems, such as distributed and centralized architectures. The operational constraints could pertain to the maximum charge rate or maximum discharge rate, temperature operational ranges, maximum depth of discharge, etc. These can be performance restrictions associated with the batteries 153.

It is then possible, at box 3020, to determine one or more operational profiles of the batteries of the BESS based on the one or load profiles of box 3005, if applicable the energy transfer rate predicted for the power grid and established at box 3010, as well as the operational constraints and/or the battery architecture as obtained at box 3015.

The operational profile can specify the currents/voltages at the batteries. Specifically, the operational profile can specify the occurrences of charging and discharging micro-operations. For example, a time sequence of charging and discharging micro-operations can be specified, i.e., the operational profile can specify a time dependency of charging and discharging. This can pertain to changes of the state of charge and depth of discharge. The operational profile can specify the concrete timings of charging or discharging micro-operations. The operational profile can specify the SoC as a function of time. The operational profile can specify the depth of discharge.

An input to an aging model can then include such operational profile. The aging model can operate based on aging parameters that translate stress factors indicated by the operational profile into aging. Typical stress factors would be mean state of charge, depth-of-discharge, temperature, charging rate, etc. These aging parameters specify an impact of certain electrical/thermal conditions of the batteries 153 on the degradation. For instance, such aging parameters can specify an impact of operating the battery in certain operation regimes (as specified by the operational profiles determined at box 3020) on the aging. For instance, such aging parameters could specify a strength of lithium plating for the batteries. The aging parameters could specify a cyclic aging for charging/discharging and/or calendar aging over time. The process of setting the aging parameters—more specifically the values of the aging parameters—can be referred to as parameterization of the aging parameters of the aging model.

Different types of batteries typically exhibit different aging parameters. Different types of batteries age differently.

According to various examples, it would be possible that aging parameters of the aging model are preset, e.g., depending on a battery type of the batteries 153. For instance, it would be possible to obtain, at box 3025, one or more operational parameters of the batteries 153 of the BESS 112 from the data repository node 123 depending on a battery type of the batteries 153. Thus, a library of aging parameters could be provided, thereby facilitating accurate prediction of loss of values for multiple types of batteries. Here, it can be assumed that batteries of the same type will experience a similar aging behavior captured by the aging model. Then, aging parameters of the aging model can be parametrized based on the one or more operational parameters is obtained from the data repository node 123.

Instead of obtaining predetermined operational parameters at box 3025 from the data repository node 123, it would also be possible to obtain such operational parameters of the batteries 153 from the battery management system 152. Then, the aging parameters of the aging model can be parametrized on such operational parameters that up are obtained for the specific instance of the BESS in the specific instance of the batteries 153.

Then, at box 3030, one or degradations of the batteries of the BESS can be determined. These one or degradations can be determined using the aging model, as explained above. The aging model can obtain, as an input, the one or more operational profiles as determined at box 3020.

Next, at box 3035, one or more losses of values of the BESS 112 are determined based on the predicted aging/degradation at box 3030. Specifically, losses of value can be determined for each interfacing mode.

Loss of value can also be referred to depreciation or shadow price, because they affect the overall profitability of operating the BESS in a respective interfacing mode. For instance, a re-sale value of the respective batteries may be reduced by the loss of value. Further, performance warranties—i.e., guaranteed operational characteristics such as lifetime, number of charging-discharging cycles—may be voided or expire.

Again, it would be possible that the one or losses of value determined at box 3035 are parametrized with respect to an energy transfer rate between the energy storage system and the power grid, in a similar fashion as explained above for the load profiles. This can mean that the loss of value is broken down into incremental changes of the value loss due to a certain operation of the BESS. The loss of value can accordingly be parametrized with respect to multiple charging and discharging micro-operations of the battery associated with each one of the one or more interfacing modes. Such techniques facilitate intra-interfacing mode optimization, i.e., appropriate operation with minimum loss of value within a given interfacing mode.

For instance, the loss of value could be specified for multiple charging or discharging micro-operations. For instance, a certain loss of value could be specified for a fast charging, another loss of value could be specified for slow charging, yet another loss of value could be specified for fast discharging with small DoD, yet another loss of value could be specified for slow discharging with high DoD, and so on, to give just a few examples.

The actual frequency of occurrence of the micro-operations can depend on the energy transfer rate requested by the power grid, i.e., the actual energy required to be transferred to from or into the power grid as a function of time and per time interval. Accordingly, it would be possible to determine occurrences of multiple charging and discharging micro-operations of the batteries 153 of the BESS 112 for each one of the one or more interfacing modes based on respective predictions of the energy transfer rates, e.g., as established at box 3010. In other words, the operational profile of the batteries 153 could be determined.

Then, an aggregated loss of value can be determined for each one of the one or more interfacing modes based on this loss value and the occurrences of each one of the multiple charging and discharging micro-operations.

More generally speaking, at box 3040, it would be possible to determine the aggregated loss of value for each one of the one or more interfacing modes based on a respective prediction of an energy transfer rate for each one of the one or more interfacing modes. Such predictions can be obtained from the grid operator of the power grid 113, or an energy exchange node 121.

it would also be possible to determine respective predictions based on environmental forecast data that is associated with an operational environment of the power grid 113. Example environmental forecast data would pertain to: weather forecasts, where e.g. colder weather is equated with higher power demand, vacation traveling forecast, etc. Environmental forecast data can be obtained from the oracle server node 122.

Next, at box 3042, it would be possible to determine one or more revenues or profits (i.e., operation reward reduced by the loss of values or aggregated losses of value and other expenses, e.g., costs of energy, personnel, and/or energy losses) for each one of the one or more interfacing modes based on power prices and the one or losses of value were aggregated losses of values. For instance, respective power prices may be obtained from the grid operator of the power grid 113 for the energy exchange node 121. Spot market prices may be considered.

At box 3045, it would then be possible to output such information—e.g., the determined one or more losses of value or aggregated losses of value, or also the determined revenues for the various interfacing modes, to an HMI.

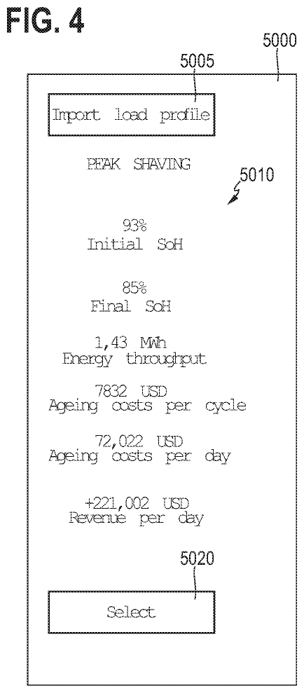

For instance, the control application could be implemented by means of a web-based planning dashboard. A web server may be implemented on the server node 111 and a respective webpage may be accessed by a user terminal node 129. This is only one option—other options would relate to outputting such information as discussed above to a control application implemented by the control unit 151. FIG. 4 schematically illustrates an example web-based graphical user interface 5000. Here, a button 5005 is provided that can be used to import a respective load profile. Then, certain information 5010 associated with the degradations determined at box 3030—e.g., the loss of value predicted—is output along the lines of the method as discussed above (e.g., here the loss value labeled “Aging costs per cycle” and the aggregated loss value labeled “Aging costs per day”). Also illustrated is a selection command button 5020 that implements a command interface to the control unit 151 associated with the BESS 112. Where the respective interfacing mode—here, peak shaving—is selected, activation of the select button 5020 can trigger activation of the peak shaving interfacing mode. This may be followed by a short-term optimization of charging and discharging micro-operations of the batteries within the peak shaving interfacing mode. This short-term optimization can be implemented at the control unit 151.

User-based selection of one or more interfacing modes is only one options. More generally, at box 3050 (cf. FIG. 3), one or more interfacing modes are selected.

For instance, the user may manually select one or more interfacing modes. The user may manually specify certain trigger criteria for activating, after go-live, each one of the one or more selected interfacing modes.

In another example, it would be possible to implement an iterative numerical optimization. As a result of the iterative numerical optimization, activation or deactivation of each one of the one or more interfacing modes can be provided as a function of time. For instance, multiple interfacing modes may be activated in parallel.

Such activation or deactivation of each one of the one or more interfacing modes may not specify the concrete operational profile for each point in time, but rather set respective constraints, as discussed above. In other words, the specific charging or discharging micro-operations may not (yet) be specified by selecting one or more interfacing modes, but rather the general framework of operating the BESS 112; this is associated with long-term planning.

For instance, such iterative numerical optimization may be implemented using a simplex algorithm or a gradient descent technique or genetic algorithms.

The iterative numerical optimization can be used to maximize or minimize a goal function. The goal function can be determined based on the one or degradations or, specifically, losses of value. In other words, the iterative numerical optimization may choose one more interfacing mode such that the overall degradation and/or losses of values of the BESS are minimized. Alternatively or additionally, the revenues may be maximized.

Depending on which one or more interfacing modes are selected or, more generally, will be used, it would then be possible at box 3055 to determine one or more set operational constraints for the batteries of the BESS based on the one or degradations as determined at box 3030. In other words, within the general operational strategy—defined by the selected one or more interfacing modes—it may be possible to find a certain operational regime of the batteries 153 of the BESS 112 that limits degradation and associated loss of value. For instance, it may be the case that one or more specific charging or discharging micro-operations are identified as causing excess degradation (and thus significant loss of value). Then, it would be possible to exclude such charging or discharging micro-operations as operational constraints from the operation. Such exclusion may be achieved by providing respective indications of the set operational constraints to the control unit 151. The control unit 151 can then control the short-term operations accordingly.

Again, an iterative numerical optimization may be used. This can be the same optimization as used in box 3050, or a separate optimization. Again, the optimization may use a goal function that is determined based on the one or more degradations. For instance, one or more losses of value or aggregated losses of value may be taken into account.

Specifically, it would be possible to provide, at box 3055, the one or operational constraints to the control unit 151 of the BESS. This can enable optimization of the charging and discharging micro-operations of the batteries within the selected at least one interfacing mode. This short-term optimization can be implemented by the control unit 151. For instance, a goal function of a respective iterative numerical optimization could consider a penalty term that penalizes use of certain charging or discharging micro-operations that are associated with a particularly high degradation or high loss of value.

Summarizing, techniques have been disclosed that facilitate selection of different interfacing modes of a BESS—power grid connection, depending on a predicted battery aging/degradation. This helps to avoid unpredicted operational failures of the BESS. Lifetime of BESSs can be maximized. This helps to reduce fixed costs and waste. Raw material required for batteries of the BESSs can be used economically and in a resource-saving manner. Further, overall profit can be increased which generally supports the proliferation of BESS. Using BESS, in turn, helps to support decentralized power generation which is helpful to support green energy, e.g., windfarms, solar power plants, etc.

Further summarizing, the following examples have been disclosed:

EXAMPLE 1. A method of operating at least one server node, the method comprising:
obtaining one or more load profiles associated with one or more interfacing modes of a battery energy storage system with an electrical utility distribution system, and
predicting one or more degradations of the battery energy storage system, the one or more degradations being associated with operating the battery energy storage system in the one or more interfacing modes, the one or more degradations being predicted using an aging model of batteries of the battery energy storage system, the aging model being based on the one or more load profiles.

EXAMPLE 2. The method of EXAMPLE 1,
wherein at least one of the one or more load profiles is predetermined for a class of electrical utility distribution systems and obtained from a data repository node or an energy exchange node.

EXAMPLE 3. The method of EXAMPLE 1 or 2,
wherein at least one of the one or more load profiles is obtained based on monitoring operation of at least one of the battery energy storage system or the electrical utility distribution system.

EXAMPLE 4. The method of any one of the preceding EXAMPLEs, further comprising:
for each one of the one or more interfacing modes, determining a respective loss of value of the battery energy storage system based on the respective degradation.

EXAMPLE 5. The method of EXAMPLE 4,
wherein the loss of value is parameterized with respect to an energy transfer rate between the battery energy storage system and the electrical utility distribution system.

EXAMPLE 6. The method of EXAMPLE 4 or 5,
wherein the loss of value is parameterized with respect to multiple charging and discharging micro-operations of the batteries associated with each one of the one or more interfacing modes.

EXAMPLE 7. The method of EXAMPLE 6, further comprising:
obtaining predictions of an energy transfer rate for each one of the one or more interfacing modes,
determining occurrences of the multiple charging and discharging micro-operations of the batteries associated with each one of the one or more interfacing modes based on the predictions of the energy transfer rate, and
estimating, based on the loss of value and the occurrences of each one of the multiple charging and discharging micro-operations of the batteries, an aggregated loss of value for each one of the one or more interfacing modes.

EXAMPLE 8. The method of any one of EXAMPLES 4 to 7, further comprising:
obtaining, from at least one of a grid operator of the electrical utility distribution system or an energy exchange node, predictions of an energy transfer rate for each one of the one or more interfacing modes, and
estimating, based on the loss of value and the predictions of the energy transfer rate, an aggregated loss of value for each one of the interfacing modes.

EXAMPLE 9. The method of any one of EXAMPLES 4 to 8, further comprising:
obtaining, from an oracle server node, environmental forecast data associated with an operational environment of the electrical utility distribution system,
determining predictions of an energy transfer rate for each one of the one or more interfacing modes based on the environmental forecast data, and
estimating, based on the loss of value and the predictions of the energy transfer rate, an aggregated loss of value for each one of the interfacing modes.

EXAMPLE 10. The method of any one of EXAMPLES 4 to 9, further comprising:
obtaining, from at least one of a grid operator of the electrical utility distribution system or an energy exchange node, power prices associated with each one of the one or more interfacing modes, and
determining revenues for each one of the one or more interfacing modes based on the power prices and the loss of value.

EXAMPLE 11. The method of any one of EXAMPLES 4 to 10,
providing, to a control unit associated with the battery energy storage system, the loss of value for at least one selected interface mode of the one or more interface modes, for optimization of charging and discharging micro-operations of the batteries within at least one selected interface mode of the one or more interface modes.

EXAMPLE 12. The method of any one of the preceding EXAMPLES, further comprising:
obtaining, from the battery energy storage system, at least one of one or more operational constraints of operation of the batteries or a network architecture of a network of the batteries,
determining, based on the one or more load profiles and the at least one of the one or more operational constraints or the network architecture of the network of batteries, one or more operational profiles for the batteries for each one of the one or more interfacing modes,
wherein an input of the aging model comprises the one or more operational profiles.

EXAMPLE 13. The method of any one of the preceding EXAMPLES, further comprising:
obtaining, from a battery management system of the battery energy storage system, operational parameters of the batteries, and
parameterizing aging parameters of the aging model based on the operational parameters.

EXAMPLE 14. The method of any one of the preceding EXAMPLES, further comprising:
obtaining, from a data repository node and based on a battery type of the batteries of the battery energy storage system, one or more operational parameters of the batteries, and
parameterizing aging parameters of the aging model based on the one or more operational parameters.

EXAMPLE 15. The method of any one of the preceding EXAMPLES, further comprising:
based on at least one of the one or more degradations predicted for the one or more interfacing modes, determining one or more set operational constraints for the batteries of the battery energy storage system, and
providing, to a control unit associated with the battery energy storage system, the one or more operational constraints, for optimization of charging and discharging micro-operations of the batteries within at least one selected interface mode of the one or more interface modes.

EXAMPLE 16. The method of any one of the preceding EXAMPLES,
wherein the one or more load profiles are obtained in a planning phase prior to a go-live of the battery energy storage system.

EXAMPLE 17. The method of any one of the preceding EXAMPLES,
wherein the one or more load profiles are obtained after a go-live of the battery energy storage system.

EXAMPLE 18. The method of any one of the preceding EXAMPLES,
wherein the interfacing modes are selected from the group consisting of: peak shaving, intra-day price arbitrage, primary power reserve, and secondary power reserve.

EXAMPLE 19. The method of any one of the preceding EXAMPLES, further comprising:
outputting information associated with the one or more degradations for each one of the one or more interfacing modes to a web-based planning dashboard.

EXAMPLE 20. The method of EXAMPLE 19,
wherein the web-based planning dashboard further comprises a command interface to a control unit associated with the battery energy storage system, for optimization of charging and discharging micro-operations of the batteries within at least one selected interface mode of the one or more interfacing modes.

EXAMPLE 21. The method of any one of the preceding EXAMPLES, further comprising:
performing an iterative numerical optimization of an activation or deactivation of each one of the one or more interfacing modes as a function of time based on a goal function that is determined based on the one or more degradations.

EXAMPLE 22. The method of any one of the preceding EXAMPLES, further comprising:
performing an iterative numerical optimization of one or more set operational constraints as a function of time for the batteries of the battery energy storage system based on a goal function that is determined based on the one or more degradations.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, scenarios have been disclosed in which a number of operations is executed on a single server node, e.g., the server node 111. As a general rule, respective techniques can also be implemented by using distributed processing across multiple server nodes, e.g., in a server cloud.

For illustration, above, various scenarios have been disclosed where one or more load profiles are obtained that are associated with one or more interfacing modes of the BESS with an electrical utility distribution system. It has been disclosed how it is possible to predict one or more degradations being associated with operating the BESS in the one or more interfacing modes. It has been disclosed how a selection of an appropriate interfacing mode becomes possible based on such predictions, e.g., considering estimated loss of values. As a general rule, the techniques disclosed herein are not only tied to selecting between different interfacing modes. For instance, it would be possible to obtain multiple load profiles that are associated with one and the same interfacing mode and it would then be possible to select appropriate operating strategies within this interfacing mode based on addicting degradations for the multiple load profiles.

What is claimed is:

1. A method of operating at least one server node, the method comprising:
obtaining one or more load profiles associated with one or more interfacing modes of a battery energy storage system with an electrical utility distribution system, and
predicting one or more degradations of the battery energy storage system, the one or more degradations being associated with operating the battery energy storage system in the one or more interfacing modes, the one or more degradations being predicted using an aging model of batteries of the battery energy storage system, the aging model being based on the one or more load profiles.

2. The method of claim 1,
wherein at least one of the one or more load profiles is predetermined for a class of electrical utility distribution systems and obtained from a data repository node or an energy exchange node.

3. The method of claim 1,
wherein at least one of the one or more load profiles is obtained based on monitoring operation of at least one of the battery energy storage system or the electrical utility distribution system.

4. The method of claim 1, further comprising:
for each one of the one or more interfacing modes, determining a respective loss of value of the battery energy storage system based on the respective degradation.

5. The method of claim 4,
wherein the loss of value is parameterized with respect to an energy transfer rate between the battery energy storage system and the electrical utility distribution system.

6. The method of claim 4,
wherein the loss of value is parameterized with respect to multiple charging and discharging micro-operations of the batteries associated with each one of the one or more interfacing modes.

7. The method of claim 6, further comprising:
obtaining predictions of an energy transfer rate for each one of the one or more interfacing modes,
determining occurrences of the multiple charging and discharging micro-operations of the batteries associated with each one of the one or more interfacing modes based on the predictions of the energy transfer rate, and
estimating, based on the loss of value and the occurrences of each one of the multiple charging and discharging micro-operations of the batteries, an aggregated loss of value for each one of the one or more interfacing modes.

8. The method of claim 4, further comprising:
obtaining, from at least one of a grid operator of the electrical utility distribution system or an energy exchange node, predictions of an energy transfer rate for each one of the one or more interfacing modes, and
estimating, based on the loss of value and the predictions of the energy transfer rate, an aggregated loss of value for each one of the interfacing modes.

9. The method of claim 4, further comprising:
obtaining, from an oracle server node, environmental forecast data associated with an operational environment of the electrical utility distribution system,
determining predictions of an energy transfer rate for each one of the one or more interfacing modes based on the environmental forecast data, and
estimating, based on the loss of value and the predictions of the energy transfer rate, an aggregated loss of value for each one of the interfacing modes.

10. The method of claim 4, further comprising:
obtaining, from at least one of a grid operator of the electrical utility distribution system or an energy exchange node, power prices associated with each one of the one or more interfacing modes, and
determining revenues for each one of the one or more interfacing modes based on the power prices and the loss of value.

11. The method of claim 4,
providing, to a control unit associated with the battery energy storage system, the loss of value for at least one selected interface mode of the one or more interface modes, for optimization of charging and discharging micro-operations of the batteries within at least one selected interface mode of the one or more interface modes.

12. The method of claim 1, further comprising:
obtaining, from the battery energy storage system, at least one of one or more operational constraints of operation of the batteries or a network architecture of a network of the batteries,
determining, based on the one or more load profiles and the at least one of the one or more operational constraints or the network architecture of the network of batteries, one or more operational profiles for the batteries for each one of the one or more interfacing modes,
wherein an input of the aging model comprises the one or more operational profiles.

13. The method of claim 1, further comprising:
obtaining, from a data repository node and based on a battery type of the batteries of the battery energy storage system, one or more operational parameters of the batteries, and
parameterizing aging parameters of the aging model based on the one or more operational parameters.

14. The method of claim 1, further comprising:
based on at least one of the one or more degradations predicted for the one or more interfacing modes, determining one or more set operational constraints for the batteries of the battery energy storage system, and
providing, to a control unit associated with the battery energy storage system, the one or more operational constraints, for optimization of charging and discharging micro-operations of the batteries within at least one selected interface mode of the one or more interface modes.

15. The method of claim 1,
wherein the one or more load profiles are obtained in a planning phase prior to a go-live of the battery energy storage system.

16. The method of claim 1, further comprising:
outputting information associated with the one or more degradations for each one of the one or more interfacing modes to a web-based planning dashboard.

17. The method of claim 16,
wherein the web-based planning dashboard further comprises a command interface to a control unit associated with the battery energy storage system, for optimization of charging and discharging micro-operations of the batteries within at least one selected interface mode of the one or more interfacing modes.

18. The method of claim 1, further comprising:
performing an iterative numerical optimization of an activation or deactivation of each one of the one or more interfacing modes as a function of time based on a goal function that is determined based on the one or more degradations.

19. The method of claim 1, further comprising:
performing an iterative numerical optimization of one or more set operational constraints as a function of time for the batteries of the battery energy storage system based on a goal function that is determined based on the one or more degradations.

20. A method of cloud-based long-term operational planning of a battery-based energy storage system, the method comprising:
obtaining load profiles for multiple interfacing modes between the battery-based energy storage system and an electrical utility distribution system,
predicting a loss of value for each one of the multiple interfacing modes based on the load profiles,
selecting one or more interfacing modes of the multiple interfacing modes based on said predicting of the loss of value.
